(19) United States
(12) Patent Application Publication
(10) Pub. No.: US 2026/0328946 A1
(43) Pub. Date: Oct. 22, 2026

(54) OFFROAD OBSTACLE DETECTION AND PATH PLANNING FOR VEHICLES

(71) Applicant: GM GLOBAL TECHNOLOGY OPERATIONS LLC, DETROIT, MI (US)

(72) Inventors: Devon Robert Hall, Ann Arbor, MI (US); Robert Dickinson Garbee, Berkley, MI (US); Jayce Lewis Delker, Farmington Hills, MI (US); Laura Foster, Farmington Hills, MI (US); Michelle Marie-Clem Brinker, St. Clair, MI (US); Mark Shawn Frye, Grosse Pointe, MI (US); Corey Jump, Lenox Township, MI (US)

(21) Appl. No.: 19/180,319

(22) Filed: Apr. 16, 2025

(51) Int. Cl. G01S 17/931; G01C 21/00; G05D 1/622; G05D 1/65; G05D 107/30

(52) U.S. Cl. CPC G01S 17/931; G01C 21/3811; G01C 21/3837; G05D 1/622; G05D 1/65; G05D 2107/30

(57) ABSTRACT

Examples described herein provide a method for offroad obstacle detection and path planning for a vehicle that includes collecting lidar data about an offroad environment in proximity to the vehicle using a lidar device of the vehicle. The method further includes detecting, using the lidar data, a hill along an offroad path that the vehicle is traveling in the offroad environment. The method further includes detecting, using the lidar data, an obstacle on the hill along the path. The method further includes generating an avoidance path for the vehicle to follow. The method further includes causing the vehicle to traverse the hill while reducing interaction with the obstacle by following the avoidance path.

### BACKGROUND

The subject disclosure relates to vehicles, and in particular to offroad obstacle detection and path planning for vehicles.

Modem vehicles (e.g., a car, a motorcycle, a boat, or any other type of automobile) may be equipped with sensors, such as a camera(s), a radar device(s), a LiDAR device(s), and/or the like for perception tasks.

LiDAR (Light Detection and Ranging, also referred to as “lidar”) is a remote sensing technology that uses laser pulses to measure distances and create precise three-dimensional (3D) maps of environments. LiDAR works by emitting rapid pulses of light, which reflect off surfaces and return to the sensor. The time-of-flight (ToF) of each pulse is used to calculate distance based on the speed of light. By scanning an area with thousands or millions of laser pulses per second, LiDAR generates highly accurate digital representations of landscapes, structures, or objects. LiDAR is useful for performing perception tasks for vehicles.

Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time and frequency change between emission and reception. The measured time can be used to determine the distance between the radar device and the detected object, while the measured frequency change in the carrier wave can be used to determine the speed difference using Doppler effect, which can be used when performing perception tasks.

Perception tasks can include one or more of object detection, classification, tracking, lane detection, road sign recognition, and obstacle detection and avoidance. Perception tasks are particularly useful for an autonomous or semi-autonomous vehicle to provide the vehicle with real-time awareness of its environment to make safe and informed driving decisions. Images from the one or more cameras of the vehicle and/or data from lidar devices and/or radar devices can be used for detecting objects, tracking targets, and/or the like, including combinations and/or multiples thereof. Perception tasks are useful for implementing advanced driver assistance systems (ADASs), providing information to drivers, and/or the like, including combinations and/or multiples thereof.

The desire for improving offroad obstacle detection and path planning is desirable for vehicles that operate in such offroad environments.

### SUMMARY

In one embodiment, a computer-implemented method for offroad obstacle detection and path planning for a vehicle is provided. The method includes collecting lidar data about an offroad environment in proximity to the vehicle using a lidar device of the vehicle. The method further includes detecting, using the lidar data, a hill along an offroad path that the vehicle is traveling in the offroad environment. The method further includes detecting, using the lidar data, an obstacle on the hill along the path. The method further includes generating an avoidance path for the vehicle to follow. The method further includes causing the vehicle to traverse the hill while reducing interaction with the obstacle by following the avoidance path.

In addition to one or more of the features described herein, or as an alternative, further embodiments of the method may include that detecting the hill includes: determining whether a hill grade is greater than a hill grade threshold, determining whether a hill length is greater than a hill length threshold, and determining whether a distance to the hill is less than a distance threshold, wherein the hill is detected responsive to determining that the hill grade is greater than the hill grade threshold, that the hill length is greater than the hill length threshold, and that the distance to the hill is less than the distance threshold.

In addition to one or more of the features described herein, or as an alternative, further embodiments of the method may include displaying a hill speed estimator gauge on a display of the vehicle.

In addition to one or more of the features described herein, or as an alternative, further embodiments of the method may include that detecting the obstacle includes: detecting a surface of the obstacle, determining an avoidance strategy, determining a clearance feasibility, and computing a minimum entry speed.

In addition to one or more of the features described herein, or as an alternative, further embodiments of the method may include that generating the avoidance path is based at least in part on an avoidance priority.

In addition to one or more of the features described herein, or as an alternative, further embodiments of the method may include that the avoidance priority is selected from a group consisting of a go around maneuver, a straddle maneuver, and a go-around maneuver.

In addition to one or more of the features described herein, or as an alternative, further embodiments of the method may include: determining whether a hill crest for the hill is within a detection range, responsive to determining that the hill crest for the hill is within the detection range, computing a speed profile, and controlling the vehicle based on the speed profile.

In addition to one or more of the features described herein, or as an alternative, further embodiments of the method may include that the controlling the vehicle is performed using a proportional-integral controller.

In addition to one or more of the features described herein, or as an alternative, further embodiments of the method may include that the controlling the vehicle is performed until the hill crest is reached.

In addition to one or more of the features described herein, or as an alternative, further embodiments of the method may include determining a size of the obstacle and a location of the obstacle, wherein the obstacle is one of a hole, a rut, a rock, or water.

In addition to one or more of the features described herein, or as an alternative, further embodiments of the method may include that the size of the obstacle and the location of the obstacle are used to generate a digital map, the digital map including the size of the obstacle and the location of the obstacle.

In addition to one or more of the features described herein, or as an alternative, further embodiments of the method may include that the digital map is available to other vehicles.

In another embodiment, a vehicle is provided. The vehicle includes a lidar sensor and a processing system that includes a memory having computer readable instructions and a processing device for executing the computer readable instructions. The computer readable instructions control the processing system to perform operations for offroad obstacle detection and path planning for the vehicle. the operations include collecting lidar data about an offroad environment in proximity to the vehicle using a lidar device of the vehicle. The operations further include detecting, using the lidar data, a hill along an offroad path that the vehicle is traveling in the offroad environment. The operations further include detecting, using the lidar data, an obstacle on the hill along the path. The operations further include generating an avoidance path for the vehicle to follow. The operations further include causing the vehicle to traverse the hill while reducing interaction with the obstacle by following the avoidance path.

In addition to one or more of the features described herein, or as an alternative, further embodiments of the vehicle may include that detecting the hill includes: determining whether a hill grade is greater than a hill grade threshold, determining whether a hill length is greater than a hill length threshold, and determining whether a distance to the hill is less than a distance threshold, wherein the hill is detected responsive to determining that the hill grade is greater than the hill grade threshold, that the hill length is greater than the hill length threshold, and that the distance to the hill is less than the distance threshold.

In addition to one or more of the features described herein, or as an alternative, further embodiments of the vehicle may include that detecting the obstacle includes: detecting a surface of the obstacle, determining an avoidance strategy, determining a clearance feasibility, and computing an minimum entry speed.

In addition to one or more of the features described herein, or as an alternative, further embodiments of the vehicle may include that generating the avoidance path is based at least in part on an avoidance priority, wherein the avoidance priority is selected from a group consisting of a go around maneuver, a straddle maneuver, and a go-around maneuver.

In addition to one or more of the features described herein, or as an alternative, further embodiments of the vehicle may include that the operations further include: determining whether a hill crest for the hill is within a detection range, responsive to determining that the hill crest for the hill is within the detection range, computing a speed profile, and controlling the vehicle based on the speed profile.

In addition to one or more of the features described herein, or as an alternative, further embodiments of the vehicle may include that the operations further include determining a size of the obstacle and a location of the obstacle, wherein the obstacle is one of a hole, a rut, a rock, or water, wherein the size of the obstacle and the location of the obstacle are used to generate a digital map, the digital map including the size of the obstacle and the location of the obstacle.

In addition to one or more of the features described herein, or as an alternative, further embodiments of the vehicle may include that the digital map is available to other vehicles.

In another embodiment a computer program product is provided. The computer program product includes a set of one or more computer-readable storage media and program instructions, collectively stored in the set of one or more computer-readable storage media, for causing a processor set to perform computer operations for offroad obstacle detection and path planning for a vehicle. The computer operations include collecting lidar data about an offroad environment in proximity to the vehicle using a lidar device of the vehicle. The computer operations further include detecting, using the lidar data, a hill along an offroad path that the vehicle is traveling in the offroad environment. The computer operations further include detecting, using the lidar data, an obstacle on the hill along the path. The computer operations further include generating an avoidance path for the vehicle to follow. The computer operations further include causing the vehicle to traverse the hill while reducing interaction with the obstacle by following the avoidance path.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A illustrates a vehicle with a processing system for performing offroad obstacle detection and path planning according to one or more embodiments;

FIG. 1B illustrates the processing system of FIG. 1A according to one or more embodiments;

FIG. 2 illustrates a method for offroad obstacle detection and path planning for vehicles, according to one or more embodiments;

FIG. 3A illustrates an image of an offroad environment according to one or more embodiments;

FIG. 3B illustrates a hill speed estimator gauge according to one or more embodiments;

FIG. 4 illustrates a flow diagram of a method for offroad obstacle detection for vehicles, according to one or more embodiments; and

FIG. 5 illustrates a block diagram of a processing system offroad obstacle detection and path planning for vehicles according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to offroad obstacle detection and path planning for vehicles. Some vehicles, like trucks and sports utility vehicles (SUVs), operate in offroad environments. An offroad environment is a natural, unpaved terrain having unpredictable and varying features, such as hills, rocks, holes, ruts, water bodies, and/or the like, including combinations and/or multiples thereof, which can present significant challenges for vehicle navigation.

In the realm of offroad vehicle navigation, detecting and navigating obstacles in offroad environments presents significant challenges. Offroad environments are unpredictable by nature, with varying terrain features, such as hills, rocks, holes, and water bodies, that can impede vehicle movement. Offroad environments are also susceptible to changing over time, such as due to weather. Approaches to obstacle detection often rely on human perception or basic sensor technologies, which may not provide the desired accuracy or reliability, particularly in low visibility conditions, such as dusk, dawn, or nighttime. This can lead to increased risk of vehicle damage and inefficient navigation paths.

Existing technologies in the field of offroad navigation typically utilize sensors like cameras and radar. However, these sensors have limitations. Cameras, for instance, struggle with low-light conditions and can provide lower confidence data due to their reliance on ambient light. Radar, while effective in certain scenarios, lacks the resolution to detect smaller, potentially hazardous objects at a distance. These limitations can result in inadequate obstacle detection and path planning, leading to suboptimal vehicle performance and increased risks.

One or more embodiments described herein address these and other shortcomings by introducing an approach for offroad obstacle detection and path planning. One or more embodiments utilizes lidar technology to provide high-confidence detection of obstacles in offroad environments, regardless of lighting conditions. By generating a near-instantaneous point cloud and elevation profile, one or more embodiments can accurately identify and classify obstacles, such as rocks, holes, ruts, and water bodies. One or more embodiments evaluates the vehicle's ability to navigate obstacles and generates an avoidance path that minimizes risk and enhances vehicle performance by attempting to avoid, or limit interaction with, such obstacles. Such embodiments not only improve operational efficiency but also offer guidance to drivers. Further, one or more embodiments can determine characteristics of detected objects, such as type, size, location, and/or the like, including combinations and/or multiples thereof, which can be used to generate a digital map that represents the objects. According to one or more embodiments, the digital map can be shared among multiple users or vehicles.

One or more embodiments detects offroad obstacles and an offroad path in front of a vehicle and evaluates the ability of the vehicle to navigate the obstacles. If a feasible path is determined to avoid or traverse the obstacles, an avoidance path is generated, which may be overlayed onto a front facing camera view. One or more embodiments also assists the vehicle in performing hill climbs, which involves climbing a hill. In the case of hill climbs, one or more embodiments uses the detected obstacles and visible hill dimensions to suggest a speed profile that can be used to climb the hill. A live speed target can be displayed to the driver using a digital display.

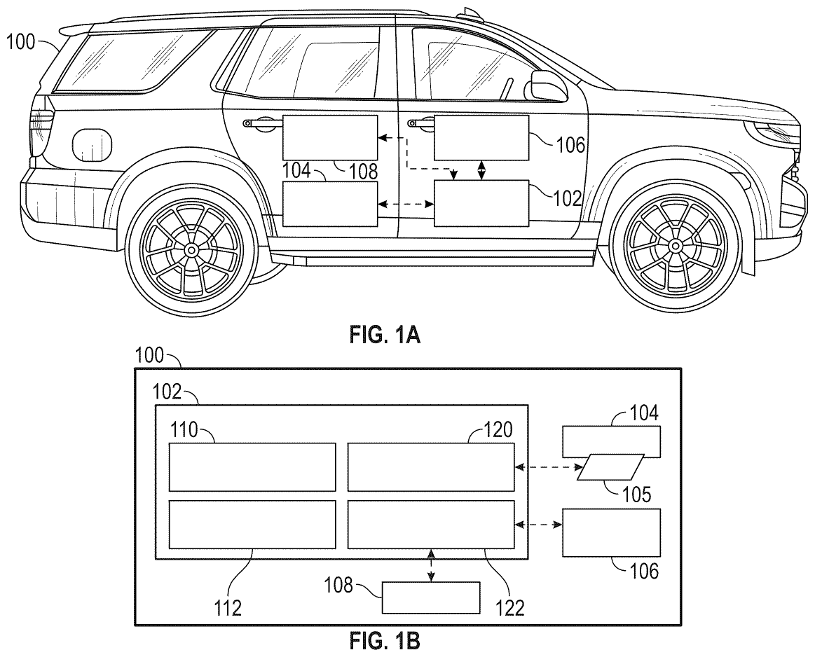

FIG. 1A shows a vehicle 100 with a processing system 102 for performing offroad obstacle detection and path planning according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 includes an internal combustion engine (not shown) that provides electrical and/or mechanical energy for providing propulsion to the vehicle 100. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The vehicle 100 includes the processing system 102, a sensor 104, a vehicle plant 106, and a display 108. The processing system 102 is located within the vehicle 100 and is responsible for managing and processing data collected by the sensor 104. The sensor 104 represents one or more sensors, which may vary in type. The sensor 104 may be any suitable sensor(s) and/or combination of sensors, such as a camera, a radar device (also referred to as a “radar sensor”), a lidar device (also referred to as a “lidar sensor”), a proximity sensor, and/or the like, including combinations and/or multiples thereof. The arrows between the sensor 104 and the processing system 102 indicate the flow of data (e.g., data 105 of FIG. 1B) from the sensor 104 to the processing system 102, highlighting the interaction between these components. This setup enables the vehicle 100 to perform perception tasks, which can be used for autonomous driving for example, using the data collected by the sensor 104.

According to one or more embodiments, the processing system 102 can be used to perform offroad obstacle detection and path planning and to control the vehicle 100 using the vehicle plant 106. The vehicle plant 106 is a collection of electromechanical components and subsystems within the vehicle 100 that are responsible for executing control commands and performing physical actions. This includes, but is not limited to, actuators, sensors, and control modules that manage various aspects of the operation of the vehicle 100, such as steering, braking, acceleration, and stability control. The vehicle plant 106 interacts with the processing system 102 to receive control signals generated by the processing system 102 and translates these signals into precise mechanical movements and adjustments for controlling the vehicle 100. This integration ensures that the vehicle 100 can respond accurately and efficiently to dynamic driving conditions, thereby enhancing the overall performance, reliability, and efficiency of the vehicle 100. The display 108 can be used to provide information to an operator or driver of the vehicle 100, such as representations of data collected by the sensor 104, information about the perception tasks, information about detected objects, information about paths for the vehicle, and/or the like, including combinations and/or multiples thereof.

Further features and functions of the processing system 102, the sensor 104, the vehicle plant 106, and/or the display 108 are now described with reference to FIG. 1B.

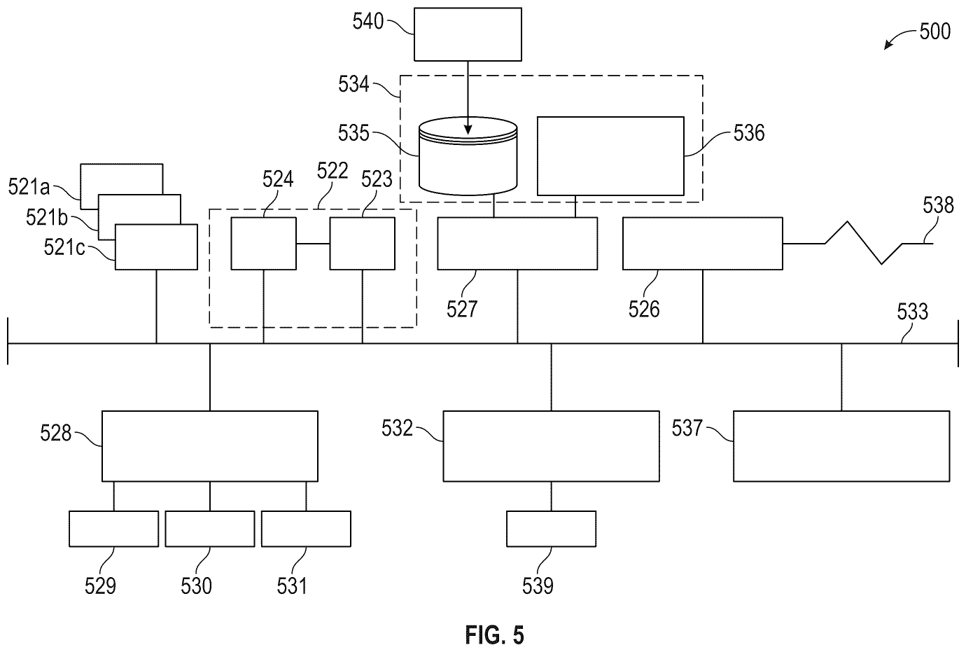

Particularly, FIG. 1B illustrates the processing system 102 of FIG. 1A according to one or more embodiments. According to one or more embodiments, the processing system 102 includes a processing device 110, a memory 112, a perception engine 120, and a guidance engine 122. It should be appreciated that the processing system 102 can be any device suitable for performing offroad obstacle detection and path planning for vehicles, such as the vehicle 100. For example, the processing system 102 can be a device implemented in or otherwise associated with the vehicle 100, such as an electronic control unit (ECU) (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 500 of FIG. 5 and/or can include one or more components of the processing system 500 of FIG. 5.

The processing device 110 is responsible for executing instructions and managing the overall operation of the processing system 102. The processing device 110 can be any suitable processing circuitry for executing instructions and processing data. For example, the processing device 110 can be a microcontroller, microprocessor, application-specific integrated circuit (ASIC), or any other type of processing unit capable of handling the computational demands of the processing system 102. The processing device 110 is an example of one or more of the processing devices 521 of FIG. 5, as described in more detail herein.

The memory 112 stores data (e.g., data 105), computer-readable instructions, and algorithms useful for operation of the processing system 102. This may include real-time data processing, historical data analysis, and storage of firmware or software programs. The memory 112 is any suitable device for storing data, such as the data 105 received from the sensor 104, and/or instructions. For example, the memory 112 can be a combination of volatile memory (e.g., random access memory) and non-volatile memory (e.g., read-only memory, flash memory). The memory 112 is an example of one or more of the system memory 522, the random access memory 523, and/or the read-only memory 524 of FIG. 5, as described in more detail herein.

The processing system 102 receives data 105 (from the sensor 104) about the vehicle 100 (e.g., telemetry data about the vehicle) and/or about the environment in which the vehicle is operating (e.g., images of objects in the environment, point cloud data of objects in the environment, etc.). According to one or more embodiments, the data 105 can be images of a path along which the vehicle 100 is traveling, including any obstacles along or in proximity to the path (e.g., rocks, ditches, holes, trees, etc.). The data 105 can be useful, for example, for performing perception tasks, which in turn are used to control the vehicle by an operator/driver of the vehicle, using an ADAS, and/or the like, including combinations and/or multiples thereof.

The perception engine 120 is responsible for performing perception tasks, such as object (e.g., obstacle) detection, classification, tracking, lane detection, road sign recognition, and obstacle detection and avoidance. For example, the perception engine 120 processes data (e.g., data 105) received from various sensors (e.g., the sensor 104), such as cameras, radar devices, and lidar devices, to perform perception tasks. By analyzing this sensor data, the perception engine 120 can generate real-time situational awareness of the environment in which the vehicle 100 operates, enabling the vehicle to make informed decisions for safe and efficient navigation, such as in offroad environments.

The guidance engine 122 is responsible for determining an avoidance path when obstacles are identified by the perception engine 120. The guidance engine 122, using the avoidance path, is responsible, at least in part, for controlling the vehicle 100. The avoidance path is a calculated route that enables the vehicle 100 to navigate efficiently with respect to detected obstacles (e.g., driving around, straddling, or driving over an obstacle). The avoidance path is generated based on various factors, including the size, location, and type of obstacles, as well as the current position and capabilities of the vehicle 100 and/or the size and shape of the vehicle 100. The guidance engine 122 takes into account the dynamics of the vehicle 100 (e.g., steering, acceleration, and braking capabilities, etc.) and environmental conditions (e.g., terrain, weather, etc.), to ensure that the avoidance path is feasible and minimizes the risk of the obstacle interfering with the vehicle 100. By dynamically adjusting the vehicle's path to generate the avoidance path in response to real-time sensor data (e.g., data 105), the guidance engine 122 ensures that the vehicle 100 can maintain optimal performance and efficiency while traversing challenging offroad environments.

According to one or more embodiments, the guidance engine 122 controls the vehicle 100 by sending commands to the vehicle plant 106, which includes electromechanical components and subsystems responsible for executing these commands. The commands from the guidance engine 122 may include steering angles, acceleration, and braking commands, among others. The guidance engine 122 dynamically adjusts these commands based on the current driving conditions, ensuring that the vehicle 100 operates efficiently. The commands are then transmitted to the vehicle plant 106, where actuators and control modules translate them into physical actions, such as turning the steering wheel, applying the brakes, or adjusting the throttle. This seamless integration between the guidance engine 122 and the vehicle plant 106 enables the vehicle 100 to respond quickly and accurately to dynamic driving environments, enhancing overall performance and operation of the vehicle 100.

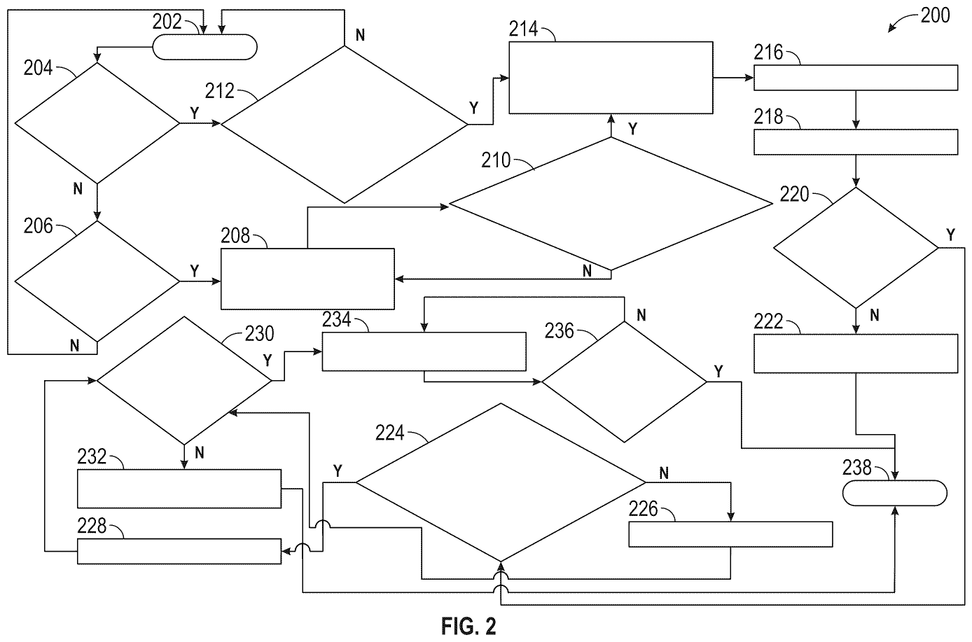

FIG. 2 illustrates a flow diagram of a method 200 for offroad obstacle detection and path planning for vehicles, such as the vehicle 100, according to one or more embodiments. The method 200 can be implemented using any suitable system or device. For example, the method 200, and its operations, can be implemented using the processing system 102 of FIGS. 1A and 1B, by the processing system 500 of FIG. 5, and/or the like, including combinations and/or multiples thereof. The method 200 provides for efficient and reliable operation of the vehicle 100 by detecting and avoiding obstacles. The method 200 is now described with reference to at least portions of FIGS. 1A and 1B but is not so limited.

The method 200 begins with operation 202. This initial operation can include receiving data, such as lidar data (e.g., the data 205) from sensor 104, such as a lidar device. Once initiated at operation 202, the method 200 proceeds to operation 204, where the processing system 102 checks if a “hill speed estimator mode” is enabled (e.g., set to “ON”).

If the hill speed estimator mode is not active (operation 204 “NO”), the method 200 proceeds to operation 206, where it is determined whether the hill speed estimator mode is in an “auto detect” state. If not (operation 206 “NO”), the method 200 returns to operation 202 and restarts. If the hill speed estimator mode is in an “auto detect” state (operation 206 “YES”), the method 200 proceeds to operation 208, where a hill speed estimator waiting message is displayed, such as on the display 108. At operation 210, it is determined whether a hill is detected by determining whether a hill exceeds an auto-detect threshold. In particular, the processing system 102 determines whether a hill grade is greater than a hill grade threshold, determines whether a hill length is greater than a hill length threshold, and determines whether a distance to hill is less than a distance threshold. If it is determined that a hill is not detected (operation 210 “NO”), the method 200 returns to operation 208. If it is determined that a hill is detected (operation 210 “YES”), the method proceeds to operation 214, which is described in more detail herein.

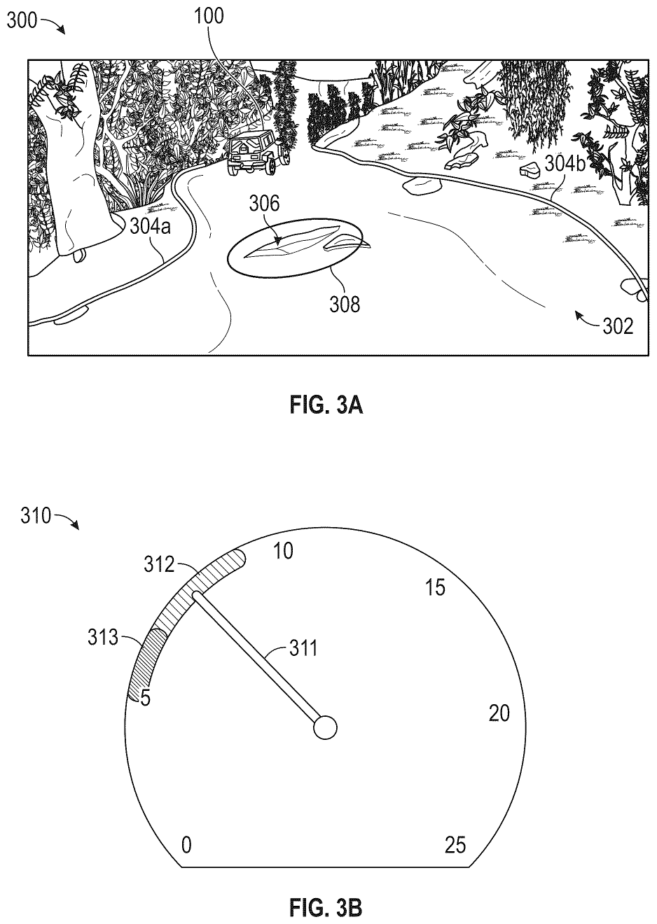

If the hill speed estimator mode is enabled (operation 204 “YES”), the method 200 proceeds to operation 212, where the processing system 102 determines whether a hill is detected using the lidar data (e.g., data 205). This includes evaluating whether the hill exceeds a manual entry threshold for grade, length, and distance to the hill. For example, the processing system 102 determines whether a hill grade is greater than a hill grade threshold, determines whether a hill length is greater than a hill length threshold, and determines whether a distance to hill is less than a distance threshold. A hill is detected responsive determining that the hill grade is greater than the hill grade threshold, that the hill length is greater than the hill length threshold, and that the distance to hill is less than the distance threshold. If no hill is detected (operation 212 “NO”), the method 200 returns to operation 202 and resumes. If a hill is detected (operation 212 “YES), the method 200 proceeds to operation 214. At operation 214, the processing system 102 displays a hill speed estimator gauge (e.g., hill speed estimator gauge 310 of FIG. 3B). This can include a message indicating that a calculation of a target hill speed is in progress, which can include determining a target hill speed, detecting obstacles, and generating an avoidance path to avoid the obstacle.

At operation 216, the processing system 102 performs obstacle detection to detect obstacles. An obstacle is defined by the following factors: an approach angle greater than a calibration value, which is a function of tire diameter and vehicle approach angle; and height (measured from start of steep to end of steep angle) greater than a calibration (function of tire diameter). Start of steep and end of steep is now described in more detail. Consider, for example, a large rock on otherwise flat ground in front of the vehicle 100. Where the rock meets the ground, the path is overall not steep because the vehicle 100 has not started moving up the rock. As the vehicle 100 starts to drive up the rock, the path grade is no longer flat. This is the “start of the steep.” The same applies towards the top of the rock. As the vehicle 100 crests the rock, the path grade becomes less steep or even flat. This the “end of the steep angle.” The start of steep is determined or measured based as a point where the derivative of path height with respect to path position is greater than or less than the surrounding area by a threshold amount. Similarly, the end of steep is where the derivative of path height with respect to path position becomes closer to zero (e.g., local maxima or minima) or closer to the gradient of the surrounding area (e.g., the surrounding hill grade). This allows for obstacles that are higher than the ground (e.g., a large rock) or ruts to be detected.

For each obstacle that is detected, the processing system 102 estimates the following factors: surface, available avoidance strategy and clearance feasibility, and minimum entry speed. The surface defines a surface type and/or characteristics (e.g., slippery, rough, smooth) and is used for friction estimation. Available avoidance strategy and clearance feasibility is based on a frontal area of the obstacle and suspension displacement of the vehicle. The avoidance strategy can be one of go around the obstacle, straddle the obstacle between the wheels of the vehicle, or go over the obstacle such that one or more of the vehicle's wheels traverses the obstacle.

For clearance feasibility, the processing system 102 applies a risk level based on an estimated proximity to the obstacle. The minimum entry speed is calculated using a conservation of energy approach, which is now described in more detail.

For each obstacle, a conservation of energy approach is applied to determine a minimum entry speed to traverse the obstacle above a calibrated target exit speed. The conservation of energy approach uses the following equations:

ExitEnergy=EntryEnergy−RoadLoadWork+TractiveWork

$$ExitEnergy = m * g * ObstacleHeight + \frac{1}{2} * m * {TargetExitSpeed}^{2}$$

$$EntryEnergy = \frac{1}{2} * m * {MinimumEntrySpeed}^{2}$$

RoadLoadWork=RoadLoadForce*ObstaclePathLength

RoadLoadForce=ForceZero+ForceOne*TargetSpeed+ForceTwo*TargetSpeed²

The ObstacleHeight and ObstaclePathLength are computed from vehicle sensors, such as sensor 104. ForceZero, ForceOne, and ForceTwo are surface dependent calibrations. For example, dirt has more rolling resistance than asphalt. The calibrations can be determined using a coast down test or simulation. According to one or more embodiments, steering related drag can be added based on path curvature.

At operation 218, based on these obstacle factors, the processing system 102, using the guidance engine 122, can develop an avoidance path between/around/over the obstacle(s) using the clearance feasibility risk and avoidance priority (e.g., go around, straddle, or go over). More particularly, the guidance engine 122 generates an avoidance path by building a route between obstacles using an avoidance priority list, which includes options such as going around, straddling, or driving over obstacles. According to one or more embodiments, for each point on the avoidance path, the processing system 102 stores the grade and estimated surface for the driven wheels. An avoidance path is a path that partially or wholly avoids one or more obstacles and/or reduces interaction between the vehicle and one or more obstacles.

The guidance engine 122 then determines, at operation 220, whether the path generation was successful. That is, was an avoidance path generated at operation 218. If unsuccessful (operation 220 “NO”), the method 200 proceeds to block 222 and generates a path generation failure message, such as on the display 108. The method 200 then proceeds to block 238 and ends. If successful (operation 220 “YES”), the method 200 proceeds to operation 224

In particular, at operation 224, the guidance engine 122 checks if the hill crest is within a detection range. If the hill crest is not within range (operation 224 “NO”), the processing system 102 computes a speed profile at operation 226. In this situation, the speed profile sets a cresting speed to be greater than a sustainable minimum speed on the grade, and factors in obstacles entered above their minimum speeds. For example, from the obstacle detection at operation 216, the minimum entry speed is determined for each obstacle. When computing the speed profile at operation 226, the speed at the obstacle position should be greater than the minimum entry speed. If not, then the vehicle 100 may become stuck at the obstacle. If the hill crest is within range (operation 224 “YES”), the processing system 102 computes a speed profile. In this situation, the speed profile sets the cresting speed to be less than a safe cresting speed (e.g., substantially 5 mph), and factors in obstacles entered above their minimum speeds. In either case, to compute the speed profile, the processing system 102 simulates longitudinal vehicle dynamics from the current state of the vehicle 100 forward along the generated avoidance path.

Subsequent to either of operations 226 or 228 being completed, the method 200 proceeds to operation 230, where it is determined whether the speed profile was computed successfully. If unsuccessful (operation 230 “NO”), the method 200 proceeds operation 232 and displays a hill speed estimator failure notification, such as on the display 108. According to one or more embodiments, a failure reason is provided with the failure message, such as insufficient friction, insufficient torque, and/or the like, including combinations and/or multiples thereof. The method 200 then proceeds to block 238 and ends. If the speed profile was computed successfully (operation 230 “YES”), the method 200 proceeds to operation 234. That is, once the speed profile is computed the processing system 102 uses a proportional-integral (PI) controller to compute a target speed for the driver to follow.

At operation 234, a hill speed estimator gauge (e.g., the hill speed estimator gauge 310 of FIG. 3B) is displayed, such as on the display 108. The hill speed estimator gauge can include a speed target, which is based on the PI controller. The PI controller is used to update the speed target as the vehicle 100 traverses the avoidance path. For example, the proportional aspect of the PI controller can be adjusted based on surface detection, with a relatively higher factor for sand or mud and a relatively lower factor for hard pack or rock. The integral aspect of the PI controller can be adjusted such that the integral aspect is incremented when the vehicle speed is below a target speed set by the speed profile. According to one or more embodiments, the PI controller includes anti-windup, which may include, for example, limiting the total magnitude of the integral term to a calibratable value or similar. The target speed is updated as more terrain is detected as the vehicle 100 traverses the avoidance path. According to one or more embodiments, the PI controller can detect wheel slip. If wheel slip is detected for longer than a threshold period, an instruction can be displayed on the display 108, such as “back down and try again.” According to one or more embodiments, if an obstacle fails clearance feasibility, the display 108 can display an indication, such as “hill speed estimate may cause vehicle damage.”

Operation 234 continues until it is determined that the hill is crested at operation 236. Specifically, if it is determined that the hill is not crested (operation 236 “NO”), the method 200 repeats operation 234. If it is determined that the hill is crested (operation 236 “YES”), the method 200 proceeds to block 238 and ends.

Additional processes also may be included, and it should be understood that the processes depicted in FIG. 2 represent illustrations, and that other processes may be added, or existing processes may be removed, modified, or rearranged without departing from the scope of the present disclosure. It should also be understood that the processes depicted in FIG. 2 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 102 of FIGS. 1A and 1B, the processing system 500 of FIG. 5, and/or the like, including combinations and/or multiples thereof), cause the processor to perform the processes described herein.

FIG. 3A illustrates an image of an offroad environment 300 according to one or more embodiments. In this example, the offroad environment 300 features a vehicle 100 navigating an offroad path 302. The offroad path 302 is delineated by offroad path boundaries 304a, 304b, which guide the vehicle's trajectory. Within the offroad environment 300, an obstacle 306 is present on the offroad path 302, highlighted by an obstacle indication 308. The image of FIG. 3A can be displayed on the display 108 as a live camera image with augmented features, such as the offroad path boundaries 304a, 304b and the obstacle indication 308, which serves to alert an operator/driver of the vehicle 100, such as to the presence of the obstacle 306.

FIG. 3B illustrates a hill speed estimator gauge 310 according to one or more embodiments. The hill speed estimator gauge 310 is designed to provide real-time feedback to the operator/driver of the vehicle 100 regarding a target (e.g., optimal) speed for navigating a hill. The hill speed estimator gauge 310 features a dial with numerical markings, shown as ranging from 0 to 25, indicating speed levels, although other values are possible in other embodiments. A needle 311 indicates the current speed of the vehicle 100, allowing the driver to adjust accordingly. The gauge has indicators 312, 313 to visually indicate safe and cautionary speeds, respectively. This visual aid assists drivers in maintaining an appropriate speed during hill climbs, enhancing efficiency and performance.

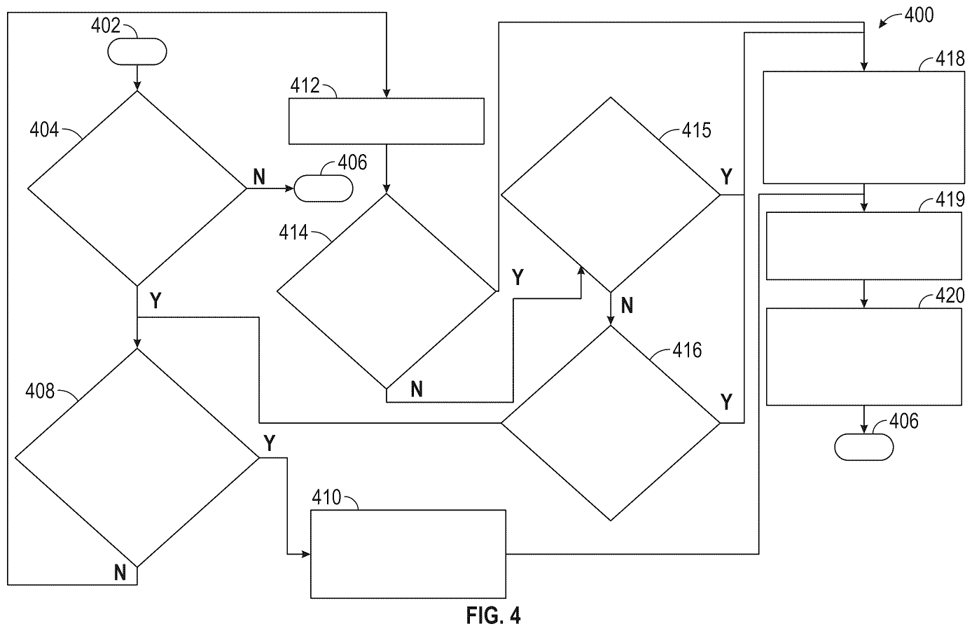

FIG. 4 illustrates a flow diagram of a method 400 for offroad obstacle detection, such as for the vehicle 100, according to one or more embodiments. The method 400 can be implemented using any suitable system or device. For example, the method 400, and its operations, can be implemented using the processing system 102 of FIGS. 1A and 1B, by the processing system 500 of FIG. 5, and/or the like, including combinations and/or multiples thereof. The method 400 provides for efficient and reliable operation of the vehicle 100 by detecting and avoiding obstacles and storing information about the obstacles in a crowdsourced map system. The method 400 is now described with reference to at least portions of FIGS. 1A and 1B but is not so limited.

The method 400 begins with operation 402, and proceeds to operation 404, where the processing system 102 checks if an “offroad mode” of the vehicle 100 is activated. The offroad mode is selected by the driver and/or automatically when the vehicle 100 is operating in an offroad environment. If the offroad mode is not active (operation 404 “NO”), the method 400 proceeds to operation 406 and ends. If the offroad mode is active (operation 404 “YES”), the method 400 proceeds to operation 408 to determine if there are any offroad map GPS locations documented within a certain range (e.g., five mile radius) of the vehicle's current position that indicate a known obstacle (e.g., hole, rut, boulder, water, etc.).

If so (operation 408 “YES”), the method 400 proceeds to operation 410, where an alert is presented on the display 108 to indicate the obstacle and a location of the obstacle on a digital map.

If not (operation 408 “NO”), the method 400 proceeds to operation 412, where a size and location of the obstacle are determined. This can be performed using lidar data from the sensor 104. For example, a near instantaneous point cloud can be generated from the lidar data along with a derived elevation profile of the environment around the vehicle 100 that can be used to detect obstacles in the offroad environment. At operation 414, it is determined whether the obstacle is able to cause damage to the vehicle 100, such as by comparing a height of the obstacle to a ground clearance of the vehicle 100. If it is determined that the obstacle is able to cause damage to the vehicle 100 (operation 414 “YES”), the method 400 proceeds to operation 418. If it is determined that the obstacle is not able (or unlikely) to cause damage to the vehicle 100 (operation 414 “NO”), the method 400 proceeds to operation 415. At operation 415, it is determined whether there is a hole or rut in the ground that could cause damage to the vehicle. If so (operation 415 “YES”), the method 400 proceeds to operation 418. If not (operation 415 “NO”), the method 400 proceeds to operation 416, where it is determined if water is present. If no water is present (operation 416 “NO”), the method returns to operation 408. If water is present (operation 416 “YES”), the method 400 proceeds to operation 418.

At operation 418 an alert is displayed on the display 108 to alert the driver of the obstacle's presence and location. According to one or more embodiments, haptic feedback and/or auditory feedback can be used to indicate the presence of the obstacle. According to one or more embodiments, the display 108 displays a live camera view of the obstacle. At operation 419, the processing system 102 suggests a driver action, such as how to navigate around the obstacle (e.g., using the avoidance path). At operation 420, the processing system 102 documents the GPS location and metadata of the obstacle, integrating this information with an offboard crowdsourced map system to alert other road users of obstacles. The method concludes at operation 406.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 102 of FIGS. 1A and 1B, the processing system 500 of FIG. 5, and/or the like, including combinations and/or multiples thereof), cause the processor to perform the processes described herein.

The technical benefits of the described embodiments include significant improvements to the functioning of vehicles, particularly in offroad environments. These improvements enhance the vehicle's reliability, efficiency, and user-friendliness. One or more embodiments utilizes lidar technology to provide high-confidence detection of obstacles regardless of lighting conditions. This capability allows for accurate identification and classification of obstacles, such as rocks, holes, and water bodies, which are common in offroad environments. One or more embodiments generates a digital map of these obstacles, which further aids in navigation. Additionally, one or more embodiments provides the ability to generate an avoidance path, which minimizes the vehicle's interaction with obstacles, reducing the risk of damage and enhancing performance of the vehicle. This path planning is based on a comprehensive analysis of obstacle characteristics, including size, location, and type, ensuring that the vehicle can navigate efficiently and safely.

One or more embodiments also provides a hill speed estimator that suggests a speed profile for climbing hills. This aspect is particularly beneficial for novice drivers, as it offers guidance on managing speed during hill climbs, thereby improving safety and efficiency. The integration of a PI controller allows for dynamic adjustment of the vehicle's speed based on real-time data. This ensures that the vehicle maintains optimal performance while traversing challenging terrains. Furthermore, the ability to share digital maps with other vehicles enhances the collective knowledge of offroad conditions, contributing to more informed driving decisions across multiple users. Overall, these technical benefits and improvements contribute to a more reliable, efficient, and user-friendly vehicle operation, particularly in challenging offroad environments.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s) 521). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 525 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for offroad obstacle detection and path planning for a vehicle, the method comprising:
collecting lidar data about an offroad environment in proximity to the vehicle using a lidar device of the vehicle;
detecting, using the lidar data, a hill along an offroad path that the vehicle is traveling in the offroad environment;
detecting, using the lidar data, an obstacle on the hill along the path;
generating an avoidance path for the vehicle to follow; and
causing the vehicle to traverse the hill while reducing interaction with the obstacle by following the avoidance path.

2. The computer-implemented method of claim 1, wherein detecting the hill comprises:
determining whether a hill grade is greater than a hill grade threshold;
determining whether a hill length is greater than a hill length threshold; and
determining whether a distance to the hill is less than a distance threshold, wherein the hill is detected responsive to determining that the hill grade is greater than the hill grade threshold, that the hill length is greater than the hill length threshold, and that the distance to the hill is less than the distance threshold.

3. The computer-implemented method of claim 1, further comprising displaying a hill speed estimator gauge on a display of the vehicle.

4. The computer-implemented method of claim 1, wherein detecting the obstacle comprises:
detecting a surface of the obstacle;
determining an avoidance strategy;
determining a clearance feasibility; and
computing an minimum entry speed.

5. The computer-implemented method of claim 1, wherein generating the avoidance path is based at least in part on an avoidance priority.

6. The computer-implemented method of claim 5, wherein the avoidance priority is selected from a group consisting of a go around maneuver, a straddle maneuver, and a go-around maneuver.

7. The computer-implemented method of claim 1, further comprising:
determining whether a hill crest for the hill is within a detection range;
responsive to determining that the hill crest for the hill is within the detection range, computing a speed profile; and
controlling the vehicle based on the speed profile.

8. The computer-implemented method of claim 7, wherein the controlling the vehicle is performed using a proportional-integral controller.

9. The computer-implemented method of claim 7, wherein the controlling the vehicle is performed until the hill crest is reached.

10. The computer-implemented method of claim 1, further comprising determining a size of the obstacle and a location of the obstacle, wherein the obstacle is one of a hole, a rut, a rock, or water.

11. The computer-implemented method of claim 10, wherein the size of the obstacle and the location of the obstacle are used to generate a digital map, the digital map including the size of the obstacle and the location of the obstacle.

12. The computer-implemented method of claim 11, wherein the digital map is available to other vehicles.

13. A vehicle comprising:
a lidar sensor; and
a processing system comprising:
a memory comprising computer readable instructions; and
a processing device for executing the computer readable instructions, the computer readable instructions controlling the processing system to perform operations for offroad obstacle detection and path planning for the vehicle, the operations comprising:
collecting lidar data about an offroad environment in proximity to the vehicle using a lidar device of the vehicle;
detecting, using the lidar data, a hill along an offroad path that the vehicle is traveling in the offroad environment;
detecting, using the lidar data, an obstacle on the hill along the path;
generating an avoidance path for the vehicle to follow; and
causing the vehicle to traverse the hill while reducing interaction with the obstacle by following the avoidance path.

14. The vehicle of claim 13, wherein detecting the hill comprises:
determining whether a hill grade is greater than a hill grade threshold;
determining whether a hill length is greater than a hill length threshold; and
determining whether a distance to the hill is less than a distance threshold,
wherein the hill is detected responsive to determining that the hill grade is greater than the hill grade threshold, that the hill length is greater than the hill length threshold, and that the distance to the hill is less than the distance threshold.

15. The vehicle of claim 13, wherein detecting the obstacle comprises:
detecting a surface of the obstacle;
determining an avoidance strategy;
determining a clearance feasibility; and
computing an minimum entry speed.

16. The vehicle of claim 13, wherein generating the avoidance path is based at least in part on an avoidance priority, wherein the avoidance priority is selected from a group consisting of a go around maneuver, a straddle maneuver, and a go-around maneuver.

17. The vehicle of claim 13, wherein the operations further comprise:
determining whether a hill crest for the hill is within a detection range;
responsive to determining that the hill crest for the hill is within the detection range, computing a speed profile; and
controlling the vehicle based on the speed profile.

18. The vehicle of claim 13, wherein the operations further comprise determining a size of the obstacle and a location of the obstacle, wherein the obstacle is one of a hole, a rut, a rock, or water, wherein the size of the obstacle and the location of the obstacle are used to generate a digital map, the digital map including the size of the obstacle and the location of the obstacle.

19. The vehicle of claim 18, wherein the digital map is available to other vehicles.

20. A computer program product comprising:
a set of one or more computer-readable storage media;
program instructions, collectively stored in the set of one or more computer-readable storage media, for causing a processor set to perform computer operations for offroad obstacle detection and path planning for a vehicle, the computer operations comprising:
collecting lidar data about an offroad environment in proximity to the vehicle using a lidar device of the vehicle;
detecting, using the lidar data, a hill along an offroad path that the vehicle is traveling in the offroad environment;
detecting, using the lidar data, an obstacle on the hill along the path;
generating an avoidance path for the vehicle to follow; and
causing the vehicle to traverse the hill while reducing interaction with the obstacle by following the avoidance path.
